(19) United States
(12) Patent Application Publication
(10) Pub. No.: US 2019/0041947 A1
(43) Pub. Date: Feb. 7, 2019

(54) TECHNOLOGIES FOR DYNAMICALLY MANAGING POWER STATES OF ENDPOINT DEVICES BASED ON WORKLOAD

(71) Applicant: Intel Corporation, Santa Clara, CA (US)

(72) Inventors: Shankar Natarajan, Folsom, CA (US); Wayne Tran, Folsom, CA (US); Vishal Mannapur, Folsom, CA (US); Anthony Giardina, Colfax, CA (US)

(21) Appl. No.: 16/022,675

(22) Filed: Jun. 28, 2018

(51) Int. Cl. G06F 1/32; G06F 13/42

(52) U.S. Cl. CPC G06F 1/325; G06F 2213/0026; G06F 13/4282; G06F 1/3206

(57) ABSTRACT

Technologies for dynamically managing a power state of a first endpoint device and a second endpoint device that are operatively coupled to a data bus of a compute device include communication monitor circuitry and power state manager circuitry. The communication monitor circuitry is configured to detect an activation signal on the data bus. The power state manager circuitry is configured to activate, in response to detection of the activation signal, the first and second endpoint devices that are operatively coupled to the data bus into a high power state from a low power state, determine, in response to activation of the first and second endpoint devices, which activated endpoint device is requested to perform work associated with the activation signal, and operate, in response to determination that the second endpoint device has no pending work to perform, the second endpoint device to return to the low power state.

### BACKGROUND

In a Peripheral Component Interconnect Express (PCIe) configuration where multiple endpoint devices are connected to a single root port and share a common clock request signal (also referred to herein as an activation signal or a CLRREQ# signal), the endpoint devices concurrently enter a high power state from a low power state in response to receiving an activation signal at the root port. Typically, the endpoint devices remain in the high power state until a particular period of time has elapsed (e.g., until a workload, such as a set of operations, associated with the activation signal has been performed by a designated endpoint device) to ensure that the workload has been completed prior to returning back to the low power state. Typically, despite the fact that work may only be required from a single endpoint device, all of the endpoint devices connected to the same root port and that share the activation signal will enter and remain in the high power state for an extended period of time to prevent performance degradation.

For example, in caching configurations, a large volume data storage and a small cache volume data storage may be operatively coupled to a local data bus. Typically, a cache hit requires an access to the small cache volume data storage, and a cache miss requires access to the large volume data storage. However, because the small cache volume data storage and the large volume data storage are coupled to the same root port on the data bus, either cache hit or cache miss instruction causes both endpoint storage devices to wake up and be ready to perform read/write operations, which may increase a total power consumption and decrease power efficiency.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a compute device that includes multiple endpoint devices;

FIG. 2 is a simplified block diagram of at least one embodiment of an environment that may be established by the compute device of FIG. 1; and

FIG. 3 is a simplified flow diagram of at least one embodiment of a method for dynamically managing a power state of the endpoint devices that are operatively coupled to a local data bus that may be executed by the compute device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

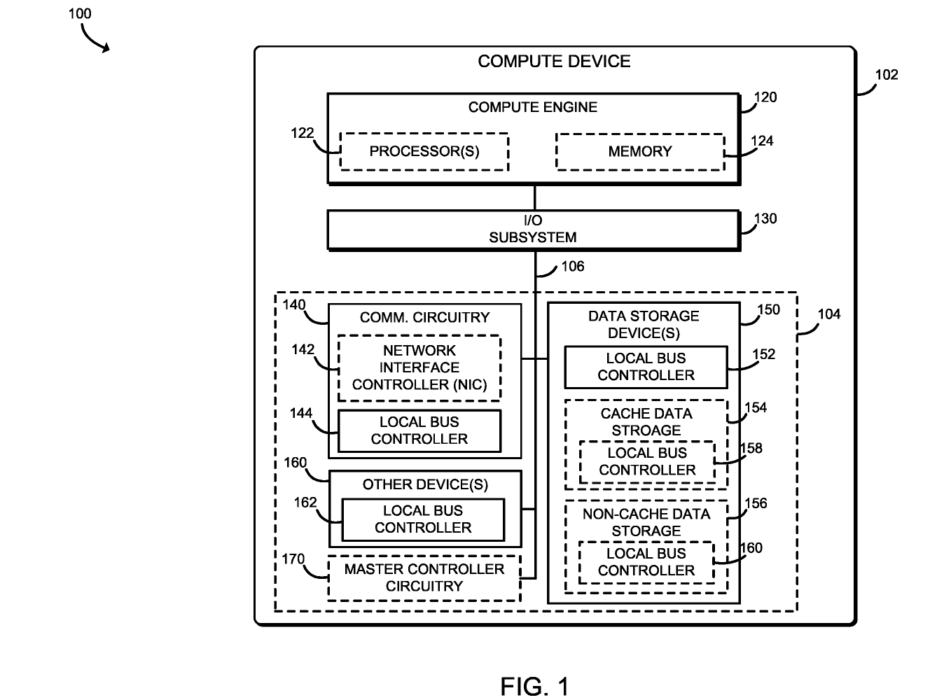

Referring now to FIG. 1, an illustrative system 100 for dynamically managing power states of endpoint devices 104 based on workload includes a compute device 102 having multiple endpoint devices 104. In use, the compute device 102 may be configured to operate the multiple endpoint devices 104 that are operatively coupled to a shared local data bus 106 to manage the power states of the endpoint devices 104 between a low power state (e.g., sleep or idle) and a high power state (e.g., active). For example, in response to detecting an activation signal on the local data bus 106, the compute device 102 may activate or wake the endpoint devices 104 such that the endpoint devices 104 are in the high power state and ready to perform workload associated with the activation signal. However, the workload may not require all endpoint devices 104 to perform. As such, the compute device 102 may determine which activated endpoint device 104 is requested to perform the workload associated with the activation signal. Once the compute device 102 determines which endpoint device 104 is required to stay active to perform the workload, the compute device 102 may operate the rest of the endpoint devices 104 that do not have any pending work to return to the low power state.

For example, the compute device 102 may include a small cache data storage 154 and a non-cache large data storage 156. In response to receiving an activation signal, the compute device 102 may operate the large data storage 156 and the small cache data storage 154 to enter into the high power state. Subsequent to determining that the activation signal includes a cache hit instruction, the compute device 102 may operate the large data storage 156 to return to sleep (i.e., the low power state), while the compute device 102 operates the small cache data storage 154 to perform the cache hit to read/write requested data from/to the small cache data storage 154. As a result, the compute device 102 may reduce a total power consumption by shortening a time period that the endpoint devices 104 with no pending work are in the high power state.

The compute device 102 may be embodied as any type of computation or compute device capable of performing the functions described herein, including, without limitation, a computer, a desktop computer, a smartphone, a workstation, a laptop computer, a notebook computer, a tablet computer, a mobile compute device, a wearable compute device, a network appliance, a web appliance, a distributed computing system, a processor-based system, and/or a consumer electronic device. As shown in FIG. 1, the illustrative compute device 102 includes a compute engine 120, an input/output (I/O) subsystem 130, communication circuitry 140, one or more data storage devices 150, and one or more other devices 160. It should be appreciated that, in other embodiments, the compute device 102 may include other or additional components, such as those commonly found in a computer. Additionally, in some embodiments, one or more of the illustrative components may be incorporated in, or otherwise form a portion of, another component.

The compute engine 120 may be embodied as any type of device or collection of devices capable of performing various compute functions described below. In the illustrative embodiment, the compute engine 120 is configured to generate an activation signal and communicate with the endpoint devices 104 via the I/O subsystem 130. For example, the compute engine 120 may generate an activation signal including a cache hit or a cache miss instruction to be performed by one or more data storage devices 150. In some embodiments, the compute engine 120 may be embodied as a single device such as an integrated circuit, an embedded system, a field-programmable gate array (FPGA), a system-on-a-chip (SoC), or other integrated system or device. In the illustrative embodiment, the compute engine 120 includes or is embodied as one or more processors 122 and a memory 124. The processor 122 may be embodied as any type of processor capable of performing the functions described herein. For example, the processor 122 may be embodied as a single or multi-core processor(s), a microcontroller, or other processor or processing/controlling circuit. In some embodiments, the processor 122 may be embodied as, include, or be coupled to an FPGA, an application specific integrated circuit (ASIC), reconfigurable hardware or hardware circuitry, or other specialized hardware to facilitate performance of the functions described herein.

The memory 124 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies. A memory device may also include other nonvolatile devices, such as a three dimensional crosspoint memory device (e.g., Intel 3D XPoint™ memory), or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. In the illustrative embodiment, the memory includes static random access memory (SRAM).

The compute engine 120 is communicatively coupled to other components of the compute device 102 (e.g., the endpoint devices 104) via the I/O subsystem 130, which may be embodied as circuitry and/or components to facilitate input/output operations with the compute engine 120 (e.g., with the processor 122 and/or the memory 124) and other components of the compute device 102. For example, the I/O subsystem 130 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 130 may form a portion of a system-on-a-chip (SoC) and be incorporated, along with one or more of the processor 122, the memory 124, and other components of the compute device 102, into the compute engine 120.

The communication circuitry 140 may be embodied as any communication circuit, device, or collection thereof, capable of enabling communications between the compute device 102 and another compute device. The communication circuitry 140 may be configured to use any one or more communication technology (e.g., wired or wireless communications) and associated protocols (e.g., Ethernet, Bluetooth®, Wi-Fi®, WiMAX, etc.) to effect such communication. The communication circuitry 140 may include a network interface controller (NIC) 142 (e.g., as an add-in device), which may also be referred to as a port logic. The NIC 142 may be embodied as one or more add-in-boards, daughter cards, network interface cards, controller chips, chipsets, or other devices that may be used by the compute device 102 to connect with another compute device. In some embodiments, the NIC 142 may be embodied as part of a system-on-a-chip (SoC) that includes one or more processors, or included on a multichip package that also contains one or more processors. In some embodiments, the NIC 142 may include a local processor (not shown) and/or a local memory (not shown) that are both local to the NIC 142. In such embodiments, the local processor of the NIC 142 may be capable of performing one or more of the functions of the compute engine 120 described herein. Additionally or alternatively, in such embodiments, the local memory of the NIC 142 may be integrated into one or more components of the compute device 102 at the board level, socket level, chip level, and/or other levels. Additionally, in the illustrative embodiment, the communication circuitry 140 further includes a local bus controller 144, which may be embodied as circuitry and/or components to control a power state transition of the communication circuitry 140 between the low and high power states. Additionally, in response to entering the high power state, the local bus controller 144 may further determine a reason for transitioning into the high power state and may operate the communication circuitry 140 to re-enter the low power state.

The one or more illustrative data storage devices 150 may be embodied as any type of devices configured for short-term or long-term storage of data such as, for example, memory devices and circuits, memory cards, hard disk drives, solid-state drives, or other data storage devices. Each data storage device 150 may include a system partition that stores data and firmware code for the data storage device 150. Each data storage device 150 may also include one or more operating system partitions that store data files and executables for operating systems. Similarly, each data storage device 150 may include a local bus controller 152. The local bus controller 152 is similar to the local bus controller 144 of the communication circuitry 140. The local bus controller 152 may be embodied as circuitry and/or components to control a power state transition of the corresponding data storage device 150 between the low and high power states. In response to entering the high power state, the local bus controller 152 may further determine a reason for transitioning into the high power state and may operate the data storage device 150 to re-enter the low power state. It should be appreciated that, in some embodiments, the data storage devices 150 may share one local bus controller 152 to control transitions of the power states of all data storage devices 150 between the low and high power states.

The one or more illustrative other devices 160 may be other or additional components, such as those commonly found in a computer (e.g., peripheral devices). Each of other devices 160 includes a local bus controller 162 that is similar to the local bus controller 144, 152. In other words, each of the endpoint devices 104 includes a corresponding local bus controller that is configured to control a power state transition of the endpoint device 104 between the low and high power states. Additionally, in response to entering the high power state, the local bus controller 162 may further determine a reason for transitioning into the high power state and may operate the other device 160 to re-enter the low power state.

In some embodiments, instead of having the local bus controllers 144, 152, 162 for each endpoint devices 104, the compute device 102 may include a master controller circuitry 170 for controlling the power states of the endpoint devices 104. The master controller circuitry 170 may be embodied as circuitry and/or components capable of performing the functions described herein. Similar to the local bus controllers 144, 152, 162, the master controller circuitry 170 may further determine a reason for transitioning into the high power state after entering the endpoint device 104 into the high power state and may operate the endpoint device 104 to re-enter the low power state.

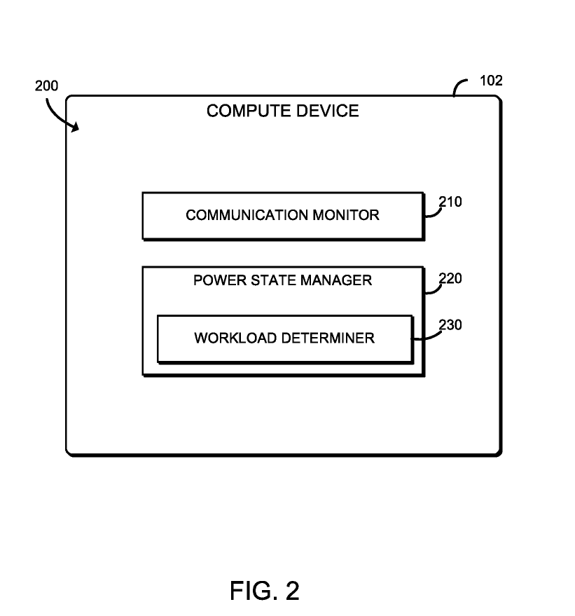

Referring now to FIG. 2, in the illustrative embodiment, the compute device 102 may establish an environment 200 during operation. The illustrative environment 200 includes a communication monitor 210 and a power state manager 220, which includes a workload determiner 230. Each of the components of the environment 200 may be embodied as hardware, firmware, software, or a combination thereof. As such, in some embodiments, one or more of the components of the environment 200 may be embodied as circuitry or a collection of electrical devices (e.g., communication monitor circuitry 210, power state manager circuitry 220, workload determiner circuitry 230, etc.). It should be appreciated that, in such embodiments, one or more of the communication monitor circuitry 210, the power state manager circuitry 220, and/or the workload determiner circuitry 230 may form a portion of a the compute engine 120 (e.g., one or more of the processor(s) 122, the memory 124), the I/O subsystem 130, the local bus controller 144, 152, 162, the master controller circuitry 170, and/or other components of the compute device 102.

The communication monitor 210, which may be embodied as hardware, firmware, software, virtualized hardware, emulated architecture, and/or a combination thereof as discussed above, is configured to monitor signal communication between the compute engine 120 (i.e., the processor(s) 122 and/or the memory 124) and the endpoint devices 104 via one or more data buses (e.g., PCIe buses). For example, the communication monitor 210 is configured to monitor one or more data buses of the compute device 102 and detect an activation signal from the compute engine 120 on one of the data buses. In the illustrative embodiment, the activation signal is to wake the endpoint devices 104 that are operatively coupled to a shared data bus 106 such that the endpoint devices 104 are ready to perform a workload associated with the activation signal. In some embodiments, the communication monitor 210 may further identify the endpoint devices 104 that are connected to the data bus 106 through the I/O subsystem 130.

The power state manager 220, which may be embodied as hardware, firmware, software, virtualized hardware, emulated architecture, and/or a combination thereof as discussed above, is configured to manage a power state of each of the endpoint devices 104 that are operatively coupled to a shared local data bus 106 (e.g., a PCIe bus). For example, the power state manager 220 is configured to activate the endpoint devices 104 that are operatively coupled to a shared local data bus 106 in response to a receipt of the activation signal. In the illustrative embodiment, the power state manager 220 may be incorporated into each of the endpoint device 104 to manage a power state of a corresponding endpoint device. However, in other embodiments, the power state manager 220 may be incorporated into the master controller circuitry 170.

As discussed above, the power state manager 220 further includes the workload determiner 230. The workload determiner 230, which may be embodied as hardware, firmware, software, virtualized hardware, emulated architecture, and/or a combination thereof as discussed above, is configured to analyze the activation signal and determine which activated endpoint device 104 is to perform the workload associated with the activation signal. Once the workload determiner 230 determines which activated endpoint device 104 is to perform the workload, the power state manager 220 may operate other activated endpoint devices 104 that do not have pending workload to return to the low power state prior to a completion of the workload by the determined endpoint device 104 to reduce a total power consumption. To do so, in some embodiments, the power state manager 220 may dynamically adjust an idle time for the other endpoint devices 104 to aggressively (e.g., faster than would otherwise occur) re-enter the low power state. The idle time is a predefined time period that elapses before an endpoint device 104 that is in the high power state re-enters the low power state. For example, endpoint PCIe devices typically have a greater idle time to prevent performance degradation.

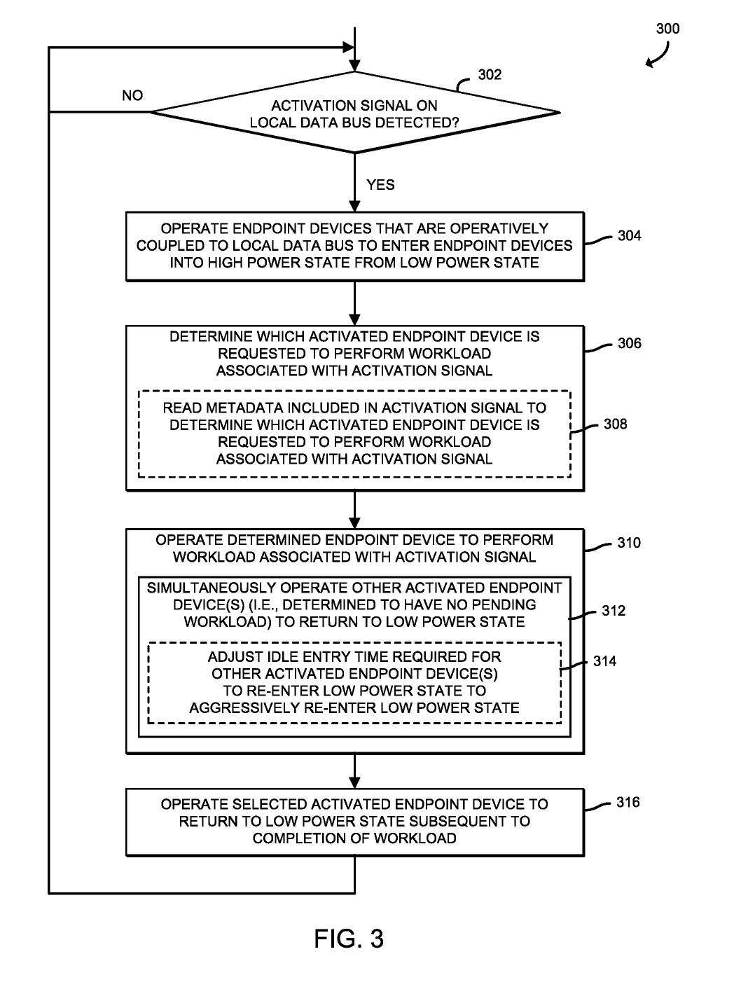

Referring now to FIG. 3, in use, the compute device 102 may execute a method 300 for dynamically managing power states of endpoint devices 104 that are operatively coupled to a local data bus 106. The method 300 begins with block 302 in which the compute device 102 determines whether an activation signal has been detected on a local data bus 106 that is operatively coupled to at least two endpoint devices 104. If the compute device 102 determines that an activation signal has not been detected, the method loops back to block 302 to continue monitoring an activation signal. If, however, the compute device 102 determines that an activation signal has been detected, the method 300 advances to block 304.

In block 304, the compute device 102 activates endpoint devices 104 that are operatively coupled to the local data bus 106 such that the endpoint devices 104 that are currently in a low power state enter a high power state. In other words, the activation signal wakes up all endpoint devices 104 that are in the low power state (e.g., sleeping or idle state) into the high power state such that the endpoint devices 104 are ready to perform workload associated with the activation signal. As discussed above, in the illustrative embodiment, the compute device 102 operates the local bus controller of each endpoint device 104 to activate the corresponding endpoint device. It should be appreciated that, in some embodiments, the compute device 102 may operate the master controller circuitry 170 to control or coordinate the endpoint devices 104 to activate the endpoint devices 104. In any event, not all of endpoint devices 104 that have been activated have a workload associated with the activation signal.

As such, in block 306, the compute device 102 determines which activated endpoint device 104 is requested to perform the workload associated with the activation signal. In other words, the compute device 102 determines the reason for the activation of the endpoint devices 104. To do so, in some embodiments, the compute device 102 may read metadata included in the activation signal to determine which activated endpoint device 104 is requested to perform the workload associated with the activation signal as illustrated in block 308. As discussed above, in some embodiments, the compute device 102 may operate the master controller circuitry 170 to determine the reason for the activation.

Subsequently, in block 310, the compute device 102 operates the determined endpoint device 104 to perform the workload associated with the activation signal. Simultaneously, in block 312, the compute device 102 operates the rest of the activated endpoint devices 104 that do not have pending workload to return to the low power state prior to a completion of the workload by the determined endpoint device. To do so, in some embodiments, the compute device 102 may dynamically adjust an idle entry time of the rest of the endpoint devices 104 to aggressively re-enter the low power state as illustrated in block 314. As such, by aggressively re-entering the endpoint devices 104 that do not have work to the low power state, the compute device 102 achieves a reduction in total power consumption.

Subsequent to the completion of the workload associated with the activation signal by the determined endpoint device 104, the compute device 102 operates the determined endpoint device 104 to return to the low power state, as illustrated in block 316. The method 300 then loops back to block 302 to continue monitoring for a next activation signal.

### EXAMPLES

Illustrative examples of the technologies disclosed herein are provided below. An embodiment of the technologies may include any one or more, and any combination of, the examples described below.

Example 1 includes a compute device for dynamically managing a power state of a first endpoint device and a second endpoint device that are operatively coupled to a data bus of the compute device, the compute device comprising communication monitor circuitry to detect an activation signal on the data bus; and power state manager circuitry to activate, in response to detection of the activation signal, the first and second endpoint devices that are operatively coupled to the data bus into a high power state from a low power state; determine, in response to activation of the first and second endpoint devices, which activated endpoint device is requested to perform work associated with the activation signal; and operate, in response to determination that the second endpoint device has no pending work to perform, the second endpoint device to return to the low power state.

Example 2 includes the subject matter of Example 1, and wherein the second endpoint device comprises a plurality of endpoint devices.

Example 3 includes the subject matter of any of Examples 1 and 2, and wherein the first and second endpoint devices are Peripheral Component Interconnect Express (PCIe) devices.

Example 4 includes the subject matter of any of Examples 1-3, and wherein to determine which activated endpoint device is requested to perform work comprises to read metadata included in the activation signal to determine which activated endpoint device is requested to perform work associated with the activation signal.

Example 5 includes the subject matter of any of Examples 1-4, and wherein to operate the second endpoint device to return to the low power state comprises to adjust an idle entry time to re-enter the low power state.

Example 6 includes the subject matter of any of Examples 1-5, and wherein the idle entry time is indicative of a time period that is to elapse before the second endpoint device re-enters the low power state.

Example 7 includes the subject matter of any of Examples 1-6, and wherein the power state manger is further to simultaneously operate, in response to determination that the first endpoint device is to perform the work, the first endpoint device to perform the work while the second endpoint device is returned to the low power state.

Example 8 includes an endpoint device for dynamically managing a power state of the endpoint device that is operatively coupled to a data bus of a compute device, the endpoint device comprising communication monitor circuitry to detect an activation signal on the data bus; and power state manager circuitry to activate, in response to detection of the activation signal, the endpoint device into a high power state from a low power state; determine, in response to activation of the endpoint device, whether the endpoint device is requested to perform work associated with the activation signal; and operate, in response to determination that the endpoint device has no pending work to perform, the endpoint device to return to the low power state.

Example 9 includes the subject matter of Example 8, and wherein the endpoint device is a Peripheral Component Interconnect Express (PCIe) device.

Example 10 includes the subject matter of any of Examples 8 and 9, and wherein to detect the activation signal on the data bus comprises to detect an activation signal on the data bus that is shared with another endpoint device.

Example 11 includes the subject matter of any of Examples 8-10, and wherein to determine whether the endpoint device is requested to perform work comprises to read metadata included in the activation signal to determine whether the endpoint device is requested to perform work associated with the activation signal.

Example 12 includes the subject matter of any of Examples 8-11, and wherein to operate the endpoint device to return to the low power state comprises to adjust an idle entry time to re-enter the low power state.

Example 13 includes the subject matter of any of Examples 8-12, and wherein the idle entry time is indicative of a time period that is to elapse before the endpoint device re-enters the low power state.

Example 14 includes one or more machine-readable storage media comprising a plurality of instructions stored thereon that, when executed, causes a compute device to detect an activation signal on the data bus; activate the first and second endpoint devices that are operatively coupled to the data bus into a high power state from a low power state; determine, in response to activation of the first and second endpoint devices, which activated endpoint device is requested to perform work associated with the activation signal; and operate, in response to determination that the second endpoint device has no pending work to perform, the second endpoint device to return to the low power state while the first endpoint device performs the work.

Example 15 includes the subject matter of Example 14, and wherein the second endpoint device comprises a plurality of endpoint devices.

Example 16 includes the subject matter of any of Examples 14 and 15, and wherein the first and second endpoint devices are Peripheral Component Interconnect Express (PCIe) devices.

Example 17 includes the subject matter of any of Examples 14-16, and wherein to determine which activated endpoint device is requested to perform work comprises to read metadata included in the activation signal to determine which activated endpoint device is requested to perform work associated with the activation signal.

Example 18 includes the subject matter of any of Examples 14-17, and wherein to operate the second endpoint device to return to the low power state comprises to adjust an idle entry time to re-enter the low power state.

Example 19 includes the subject matter of any of Examples 14-18, and wherein the idle entry time is indicative of a time period that is to elapse before the second endpoint device re-enters the low power state.

Example 20 includes the subject matter of any of Examples 14-19, and further including a plurality of instructions that in response to being executed cause the compute device to simultaneously operate, in response to determination that the first endpoint device is to perform the work, the first endpoint device to perform the work while the second endpoint device is returned to the low power state.

Example 21 includes a method for managing a power state of first and second endpoint devices coupled to a data bus of a compute device, the method comprising detecting, by the compute device, an activation signal on the data bus; activating, by the compute device, the first and second endpoint devices that are operatively coupled to the data bus into a high power state from a low power state; determining, in response to activation of the first and second endpoint devices and by the compute device, which activated endpoint device is requested to perform work associated with the activation signal; and operating, in response to determination that the second endpoint device has no pending work to perform and by the compute device, the second endpoint device to return to the low power state while the first endpoint device performs the work.

Example 22 includes the subject matter of Example 21, and wherein the second endpoint device comprises a plurality of endpoint devices.

Example 23 includes the subject matter of any of Examples 21 and 22, and wherein the first and second endpoint devices are Peripheral Component Interconnect Express (PCIe) devices.

Example 24 includes the subject matter of any of Examples 21-23, and wherein determining which activated endpoint device is requested to perform work comprises reading, by the compute device, metadata included in the activation signal to determine which activated endpoint device is requested to perform work associated with the activation signal.

Example 25 includes the subject matter of any of Examples 21-24, and wherein operating the second endpoint device to return to the low power state comprises adjusting, by the compute device, an idle entry time to re-enter the low power state.

Example 26 includes the subject matter of any of Examples 21-25, and wherein the idle entry time is indicative of a time period that is to elapse before the second endpoint device re-enters the low power state.

Example 27 includes the subject matter of any of Examples 21-26, and further including simultaneously performing, in response to determination that the first endpoint device is to perform the work and by the compute device, the work while the second endpoint device is returned to the low power state.

1. A compute device for dynamically managing a power state of a first endpoint device and a second endpoint device that are operatively coupled to a data bus of the compute device, the compute device comprising:
communication monitor circuitry to detect an activation signal on the data bus; and
power state manager circuitry to:
activate, in response to detection of the activation signal, the first and second endpoint devices that are operatively coupled to the data bus into a high power state from a low power state;
determine, in response to activation of the first and second endpoint devices, which activated endpoint device is requested to perform work associated with the activation signal; and
operate, in response to determination that the second endpoint device has no pending work to perform, the second endpoint device to return to the low power state.

2. The compute device of claim 1, wherein the second endpoint device comprises a plurality of endpoint devices.

3. The compute device of claim 1, wherein the first and second endpoint devices are Peripheral Component Interconnect Express (PCIe) devices.

4. The compute device of claim 1, wherein to determine which activated endpoint device is requested to perform work comprises to read metadata included in the activation signal to determine which activated endpoint device is requested to perform work associated with the activation signal.

5. The compute device of claim 1, wherein to operate the second endpoint device to return to the low power state comprises to adjust an idle entry time to re-enter the low power state.

6. The compute device of claim 5, wherein the idle entry time is indicative of a time period that is to elapse before the second endpoint device re-enters the low power state.

7. The compute device of claim 1, wherein the power state manger is further to simultaneously operate, in response to determination that the first endpoint device is to perform the work, the first endpoint device to perform the work while the second endpoint device is returned to the low power state.

8. An endpoint device for dynamically managing a power state of the endpoint device that is operatively coupled to a data bus of a compute device, the endpoint device comprising:
communication monitor circuitry to detect an activation signal on the data bus; and
power state manager circuitry to:
activate, in response to detection of the activation signal, the endpoint device into a high power state from a low power state;
determine, in response to activation of the endpoint device, whether the endpoint device is requested to perform work associated with the activation signal; and
operate, in response to determination that the endpoint device has no pending work to perform, the endpoint device to return to the low power state.

9. The endpoint device of claim 8, wherein the endpoint device is a Peripheral Component Interconnect Express (PCIe) device.

10. The endpoint device of claim 8, wherein to detect the activation signal on the data bus comprises to detect an activation signal on the data bus that is shared with another endpoint device.

11. The endpoint device of claim 8, wherein to determine whether the endpoint device is requested to perform work comprises to read metadata included in the activation signal to determine whether the endpoint device is requested to perform work associated with the activation signal.

12. The endpoint device of claim 8, wherein to operate the endpoint device to return to the low power state comprises to adjust an idle entry time to re-enter the low power state.

13. The endpoint device of claim 12, wherein the idle entry time is indicative of a time period that is to elapse before the endpoint device re-enters the low power state.

14. One or more machine-readable storage media comprising a plurality of instructions stored thereon that, when executed, causes a compute device to:
detect an activation signal on the data bus;
activate the first and second endpoint devices that are operatively coupled to the data bus into a high power state from a low power state;
determine, in response to activation of the first and second endpoint devices, which activated endpoint device is requested to perform work associated with the activation signal; and
operate, in response to determination that the second endpoint device has no pending work to perform, the second endpoint device to return to the low power state while the first endpoint device performs the work.

15. The one or more computer-readable storage media of claim 14, wherein the second endpoint device comprises a plurality of endpoint devices.

16. The one or more computer-readable storage media of claim 14, wherein the first and second endpoint devices are Peripheral Component Interconnect Express (PCIe) devices.

17. The one or more computer-readable storage media of claim 14, wherein to determine which activated endpoint device is requested to perform work comprises to read metadata included in the activation signal to determine which activated endpoint device is requested to perform work associated with the activation signal.

18. The one or more computer-readable storage media of claim 14, wherein to operate the second endpoint device to return to the low power state comprises to adjust an idle entry time to re-enter the low power state.

19. The one or more computer-readable storage media of claim 18, wherein the idle entry time is indicative of a time period that is to elapse before the second endpoint device re-enters the low power state.

20. The one or more computer-readable storage media of claim 14, further comprising a plurality of instructions that in response to being executed cause the compute device to simultaneously operate, in response to determination that the first endpoint device is to perform the work, the first endpoint device to perform the work while the second endpoint device is returned to the low power state.
